(19) United States
(12) Patent Application Publication
(10) Pub. No.: US 2015/0154640 A1
(43) Pub. Date: Jun. 4, 2015

(54) METHOD AND SYSTEM FOR COLLECTING RESOURCE ACCESS INFORMATION

(71) Applicant: Alibaba Group Holding Limited, George Town (KY)

(72) Inventors: Ping Qiao, Hangzhou (CN); Pan Cao, Hangzhou (CN)

(21) Appl. No.: 14/543,467

(22) Filed: Nov. 17, 2014

(30) Foreign Application Priority Data
Dec. 4, 2013 (CN) 201310646289.X

(51) Int. Cl. G06Q 30/02; H04L 29/08; H04L 12/911

(52) U.S. Cl. CPC G06Q 30/0261; H04L 47/70; H04L 67/18

(57) ABSTRACT

Embodiments of the present application relate to a method for collecting resource access information, a system for collecting resource access information, and a computer program product for collecting resource access information. A method for collecting resource access information is provided. The method includes acquiring an access request sent by a user terminal, the access request being generated by the user terminal based on a scanned information code, acquiring resource content and geographic location information of the user terminal based on the access request, determining an advertisement delivering location from a resource database that corresponds to the resource content and that is closest to the geographic location information of the user terminal, and collecting session access information relating to the advertisement delivering location.

### CROSS REFERENCE TO OTHER APPLICATIONS

This application claims priority to People's Republic of China Patent Application No. 201310646289.X entitled A METHOD AND A DEVICE FOR COLLECTING RESOURCE ACCESS INFORMATION, filed Dec. 4, 2013 which is incorporated herein by reference for all purposes.

### FIELD OF THE INVENTION

The present invention relates to a method and system for collecting resource access information.

### BACKGROUND OF THE INVENTION

As technology develops, resource delivery (e.g., advertisement delivery) has appeared in new forms, such as Quick Response (QR) codes. “QR codes” are images that are distributed two-dimensionally in alternating black and white according to definite patterns in a specific geometric shape. The QR codes are used to record data symbols. In advertisement delivery, a QR code can be generated from advertised resource content. Typically, users are provided with a fast resource access channel via a URL (Uniform Resource Locator) stored as a QR code. An example of a fast resource access channel includes converting a URL into a QR code, scanning the QR code using a mobile phone, and directly visiting an advertisement page via the URL. This fast resource access channel allows users to skip manually entering website addresses, and achieves organic online-offline integration, thereby increasing attention levels. Resources to be accessed include but are not limited to: text, pictures, video, music, apps, and promotional information. QR codes can be seen in places such as on merchandise packages, web pages, cafes, supermarkets, metros, malls, and bus stops.

In order to help advertisers increase the effectiveness of advertisement delivering, and to provide reference information for personalized, targeted advertisement delivering, resource access information is collected. A current approach for collecting resource access information involves adding parameters identifying advertising channels and parameters for advertising locations within the resource content and then generating QR codes. Thus, when a user scans a QR code and accesses a corresponding resource, a server can acquire the advertising channel information and advertising location from a resource request and thereby collect resource access information. However, such an approach involves generating a different QR code for each advertisement delivering location, is complex to implement in a case involving thousands of advertisement delivering locations, and has excessive production cost. Collecting information relating to the effectiveness of advertisement delivering locations is used to evaluate the effectiveness of the advertisement delivering locations. Evaluation of the effectiveness of different advertisement delivering locations is to be performed at a granularity level of specific advertisement delivering locations, so specific data can be gathered for an advertisement distribution. An evaluation technique is to use a unique ID to distinguish each specific advertisement delivering location. This technique is feasible for a limited amount of advertisement delivering locations, but costs increase significantly when more advertisement delivering locations exist.

### BRIEF DESCRIPTION OF THE DRAWINGS

Various embodiments of the invention are disclosed in the following detailed description and the accompanying drawings.

FIG. 1A is a flowchart illustrating an embodiment of a process for collecting resource access information.

FIG. 1B is a flowchart illustrating another embodiment of a process for collecting resource access information.

FIG. 2 is a structural diagram illustrating an embodiment of a device for collecting resource access information.

FIG. 3 is a structural diagram illustrating another embodiment of a device for collecting resource access information.

FIG. 4 is a diagram illustrating an embodiment of a system for collecting resource access information.

FIG. 5 is a diagram illustrating an embodiment of a computer system for collecting resource access information.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The present application describes the following: A QR code or an information code is generated based on advertised resource content, but an additional QR code or an additional information code is not generated for each advertisement delivering location. In the event that a user terminal scans a QR code, acquires the resource content, and sends an access request relating to the resource content to a server, the user terminal also sends geographic location information of the user terminal to the server. In some embodiments, the access request related to the user's visit and information are typically gathered by adding a tag. The server determines an advertisement delivering location in a resource database that corresponds to the resource content and that is closest to the geographic location information of the user terminal. The server collects resource access information relating to the advertisement delivering location of the resource content. For example, resource access information includes when, where, who, time of visit, location of the visitor, user identifier, etc. In some embodiments, an advertisement corresponds to promotional information. In some embodiments, the advertisement corresponds to text, picture, video, music, etc.

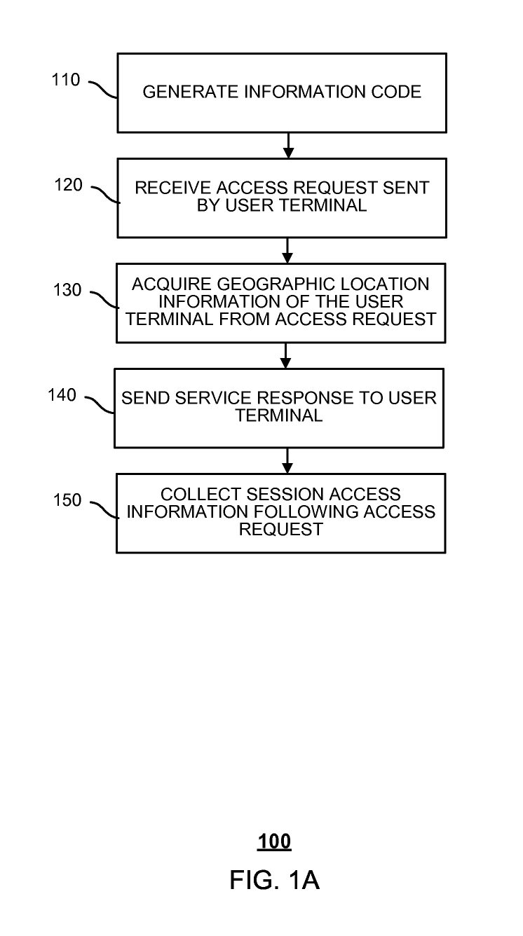

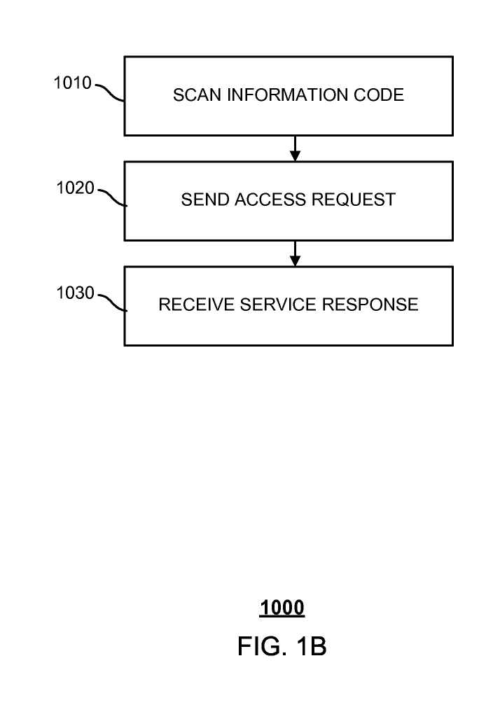

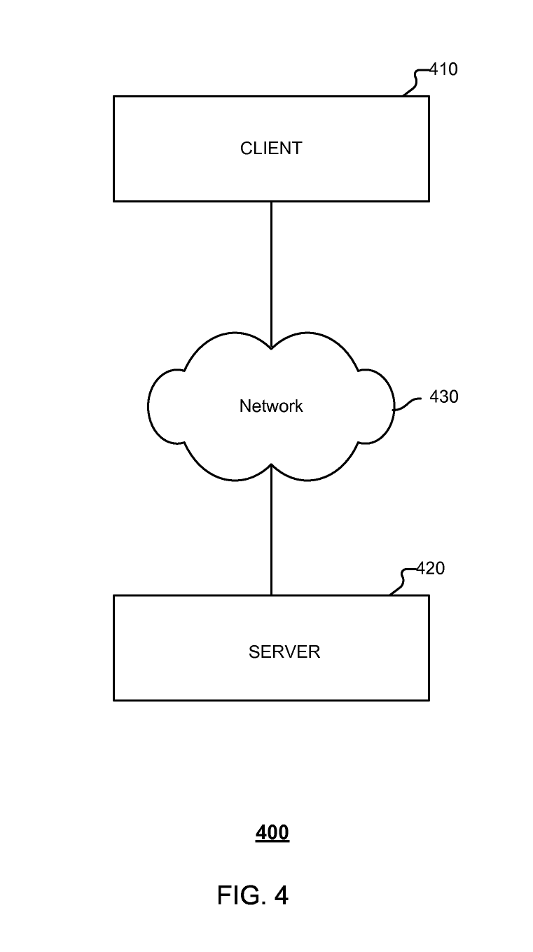

FIG. 1A is a flowchart illustrating an embodiment of a process for collecting resource access information. In some embodiments, the process 100 is implemented by a server 420 of FIG. 4 and comprises:

In 110, a server generates an information code or QR code based on promotional information content. In some embodiments, the information code is advertised in various advertisement delivering locations, and the server maintains a resource database including the various advertisement delivering locations. In some embodiments, a preconfigured database storing corresponding relationships of the advertisement delivering location and the geographical information of the advertisement delivering location exists. Typically, for outdoor advertisements, the advertisement delivering location is fixed.

In some embodiments, the promotional information content corresponds to a uniform resource locator (URL) related to promotional information. The promotional information or the advertisement includes a URL that a user scans, via e.g., a smartphone, and directly visits an advertisement page. In some embodiments, the URL is included in the information code. Thus, only one information code is to be generated for the same promotional information content. Subsequently, this information code can be used in various advertisement delivering locations. The aforementioned resource database includes promotional information content, advertisement delivering locations, geographic location information corresponding to the advertisement delivering locations, etc. In some embodiments, the geographic location information corresponding to the advertisement delivering locations is latitude and longitude information. In some embodiments, the advertisement delivering locations are also represented by specific names, identifiers, themes, etc. In addition, in some embodiments, the resource database includes advertising cooperation channel information. An advertising cooperation channel refers to an advertisement distributor. In some embodiments, the advertising cooperation channels include multiple channels participating in advertisement distribution. Based on an analysis of the advertising delivering locations and the corresponding advertising cooperation channel of the distributor participating in the distribution of the advertisement, the effectiveness of the advertisement distribution at the level of the distributors can be determined.

Table 1 includes an example of information contained in a resource database. In Table 1, three advertisement delivering locations corresponding to URL1 are provided. The advertisement delivering locations are the following: “Bullet Train No. D5678, Car 1,” “Century Mart, Hua Shang Branch, No. 1 Garage Entrance,” and “No. 3 International Building, Xihu, Hangzhou.” Geographic location information corresponding to “Century Mart, Hua Shang Branch, No. 1 Garage Entrance” and “No. 3 International Building, Xihu, Hangzhou” are longitude=116″ 3′ and latitude=39″ 26′, and longitude=96″ 18′ and latitude=33″ 16′, respectively. The geographic location information corresponding to “Bullet Train No. D5678, Car 1” corresponds to a moving vehicle, so the geographic location information of “Bullet Train No. D5678, Car 1” does not have a fixed latitude and longitude. In some embodiments, in the event that an advertisement delivering location does not have a fixed location, e.g., trains or other moving objects, the geographic location information is left blank.

TABLE 1

| Promotional | Name of | | Geographic |
|---|---|---|---|
| information | advertisement | Advertising | location |
| content | delivering location | cooperation channel | information |
| URL1 | Bullet train No. | Shanghai Railway | |
| | D5678, Car 1 | Bureau | |
| | Century Mart, Hua | Hangzhou Lianhua | Longitude = |
| | Shang Branch, No. 1 | Supermarket | 116″ 3′, |
| | Garage Entrance | Holdings | Latitude = |
| | | | 39″ 26′ |
| | No. 3 International | Zhejiang Energy | Longitude = |
| | Building, Xihu, | Conservation | 96″ 18′, |
| | Hangzhou | Company property | Latitude = |
| | | | 33″ 16′ |

Typically, after scanning the information code, a user terminal analyzes the scanned information code and obtains the promotional information content from the scanned information code. Please note that obtaining promotional information content from a scanned information code is understood by one of ordinary skill in the art, so a further description will not be provided for conciseness.

In some embodiments, the user terminal scans the information code based on a picture-taking function of the user terminal, analyzes the information code, and acquires the promotional information content from the analyzed information code. In some embodiments, the promotional information content corresponds to a URL.

In some embodiments, the user terminal sends an access request including geographic location information of the user terminal to the server and corresponding to the promotional information content.

In some embodiments, before sending the access request to the server, the user terminal first establishes a location of the user terminal by using a positioning function of the user terminal and thus acquires the geographic location information of the user terminal. Subsequently, the user scans a QR code to initiate a request for a URL. For example, the server obtains the user's geographical location information when the user scans the QR code where the geographical location is described using latitude and longitude information. Based on the user's geographical location, the server can locate in a table, e.g., table 1, an advertisement delivering location that is the closest to the user's geographical location and regard the found advertisement delivering location as the location of the advertisement that the user just scanned. In some embodiments, the geographic location information of the user terminal is established based on a positioning technology such as global positioning system (GPS) positioning, Wi-Fi positioning, base station positioning, etc. In some embodiments, the geographic location information is stored as latitude and longitude information, which can uniquely determine a geographic location.

In some embodiments, when the user terminal sends an access request, the access request includes the geographic location information of the user terminal in the form of a URL parameter in a URL corresponding to the promotional information content. For example, for moving objects, a user cannot easily scan a QR code to determine the advertisement delivery location, so traditional labeling techniques are to be used. For example, a unique ID is placed in the advertisement delivery location in the URL parameters for data collection purposes. Thus, when the server receives the access request, the server can acquire the geographic location information of the user terminal.

In 120, the server receives the access request sent by the user terminal.

In 130, the server acquires geographic location information of the user terminal from the access request. In some embodiments, the server determines an advertisement delivering location from the resource database that corresponds to the resource content and that is closest to the geographic location information of the user terminal. Based on the latitude and longitude of the two locations (the user terminal and the advertisement delivery locations), the server can take the distance between the two locations and determine the advertisement delivery location having the shortest distance from the user terminal.

In some embodiments, the server collects the resource access information in real time. In some embodiments, the server records received access requests in an access log, and the server acquires geographic location information of user terminals from access requests in the access log periodically or in real time when access occurs. Then, the server collects the resource access information. For example, the resource access information pertaining to a session includes a time of visit, an IP address, the URL being accessed, etc.

In some embodiments, since the server-maintained resource database includes advertisement delivering locations and promotional information content, the server determines which advertisement delivering location among all the resource advertising locations corresponding to the promotional information content has the shortest distance from the geographic location information of the user terminal. As used above, “distance” can be the planar distance between two points, or the distance between two points on a spherical surface.

In some embodiments, if the distance between the advertisement delivering location that is closest to the geographic location information of the user terminal and the geographic location information of the user terminal exceeds a permitted or predetermined threshold value, the accuracy of the resource database configuration can be checked, and the data can be modified through manual intervention if the data is incorrect. For example, using the shortest distance between the two geographical locations to determine which advertisement delivery location is being visited, and assuming the distance between the user's scanning location and each advertisement delivery location in the table exceeds a threshold, then a modification or an addition is to be entered manually because location data may possibly be missing in the table or an inaccuracy exists in a latitude value and/or a longitude value of an advertisement delivery location in the table.

In 140, upon receiving the access request, the server sends a service response to the user terminal, i.e., to push the user terminal request result to the user terminal. For example, in the event that the information code scanned by the user terminal is a promotional information URL, the server, upon receiving the access request, is to push the promotional information page corresponding to the URL to the user terminal. Furthermore, in some embodiments, the server fully utilizes the geographic location information of the user terminal and pushes promotional information that is closest to the user terminal to the user terminal. For example, because the server has already collected the user's geographical location information, the server can send location-based information to the user. For example, if the user is trying to buy clothes, the server can send discount or other promotional information related to the closest clothing store to the user.

In 150, the server collects session access information following receipt of the access request as resource access information relating to the advertisement delivering location.

In some embodiments, all session access following the access request is regarded as traffic caused by the advertisement delivering location. Therefore, the collecting of the resource access information relating to the advertisement delivering location includes collecting the session access information following the access request as resource access information corresponding to the advertisement delivering location. The collected resource access information can be recorded in a database and made available for use in later analysis. The subsequent session access information includes: the user terminal IP address, access times, entry page URLs, entry page access origin page URLs, at least one browser feature, etc.

The IP address of the user terminal can be acquired from the source IP address information of the access request. In some embodiments, at least one access request in the session access information subsequent to the access request also uses the same source IP address information.

The browser feature can correspond to a cookie included in the access request. In the event that the access request includes a cookie, the access request including the cookie indicates that the user (typically manifested as the browser) has accessed the target website. In some embodiments, at least one access request in the session access information subsequent to the access request also includes the same cookie. In the event that the access request does not include a cookie, the access request not including the cookie indicates that the user terminal is accessing the target website for the first time (or that the previous cookie was deleted). In this scenario, the server creates a cookie for the user and allocates the cookie to the user terminal. At least one access request in the session access information subsequent to the access request will include the cookie.

The “entry page URL” refers to the entry page URL of each access request in the subsequent session access information. The “entry page access origin page URL” refers to the URL one jump prior to the entry page URL, i.e., the web page address immediately prior to the entry page URL.

The above process 100 helps collect data and determine effectiveness of the advertisement delivery locations and standard measurements for internet traffic quality can be used including the number of page views, the number of unique visitors, etc. For example, after determining the effectiveness of a specific advertisement delivery location, a determination can be made as to whether the specific advertisement delivery location should be maintained or eliminated.

The above process 100 describes acquiring resource access information corresponding to each advertisement delivering location. In this way, analyzing the results of advertisement delivering is possible. For example, an optimal advertisement delivering location can be analyzed, an optimal advertisement delivering time interval can be analyzed, etc. Various specific parameters, such as Page Views (PV), Unique Visitors (UV), bounce rate, conversion rate, new visitor percentage, etc., can be calculated for the advertisement and can then be used for personalized, targeted advertising. Page view relates to the number of visits to a page, unique visitors relates to the number of visitors from different IP addresses, bounce rate refers to the rate of visits by users who found the website using a keyword search but left after viewing one page relative to a total number of visits (the bounce rate helps determine how attractive a website is to users), conversion rate relates to a number of visits that lead to a certain action divided by a total number of visits (the conversion rate also helps evaluate a website's attractiveness to the users), and new visitor percentage relates to a number of new visitors during a period divided by a total number of visitors during the period. For example, an effectiveness assessment report including these parameters is generated according to a set template for each resource advertisement. In another example, an audience behavior model, a resource thermodynamic map model, or other models known to those skilled in the art are established. In yet another example, the advertisement delivering strategy can be adjusted based on an advertisement delivering model. The above process 100 can achieve a granular precision in analyzing information code advertising effectiveness that is specific to the advertising location of each information code, which is a relatively fine analytic granularity.

In addition, when the server receives the access request, the server can first attempt to acquire the advertisement delivering location directly from the access request, e.g., the advertisement delivering location name, identifier, or theme. This acquisition could accommodate existing methods of collecting resource access information. In some embodiments, the access request can also contain advertising channel information. In the event that the advertisement delivering location can be acquired directly, the server can record the session access information subsequent to the access request as resource access information corresponding to the advertisement delivering location. In the event that the advertisement delivering location cannot be acquired directly from the access request, the server can determine the advertisement delivering location based on the geographic location information of the user terminal included in the access request, as described above.

FIG. 1B is a flowchart illustrating another embodiment of a process for collecting resource access information. In some embodiments, the process 1000 is implemented by a client 410 of FIG. 4 and comprises:

In 1010, the client scans an information code to acquire resource access content.

In 1020, the client sends, to a server, an access request including geographic location information of the client that relates to the resource access content. Upon receiving the access request, the server determines an advertisement delivering location in a resource database that corresponds to the resource access content and that is closest to the geographic location information of the client, sends a service response to the client, and collects session access information relating to the advertisement delivering location.

In 1030, the client receives a service response from a server.

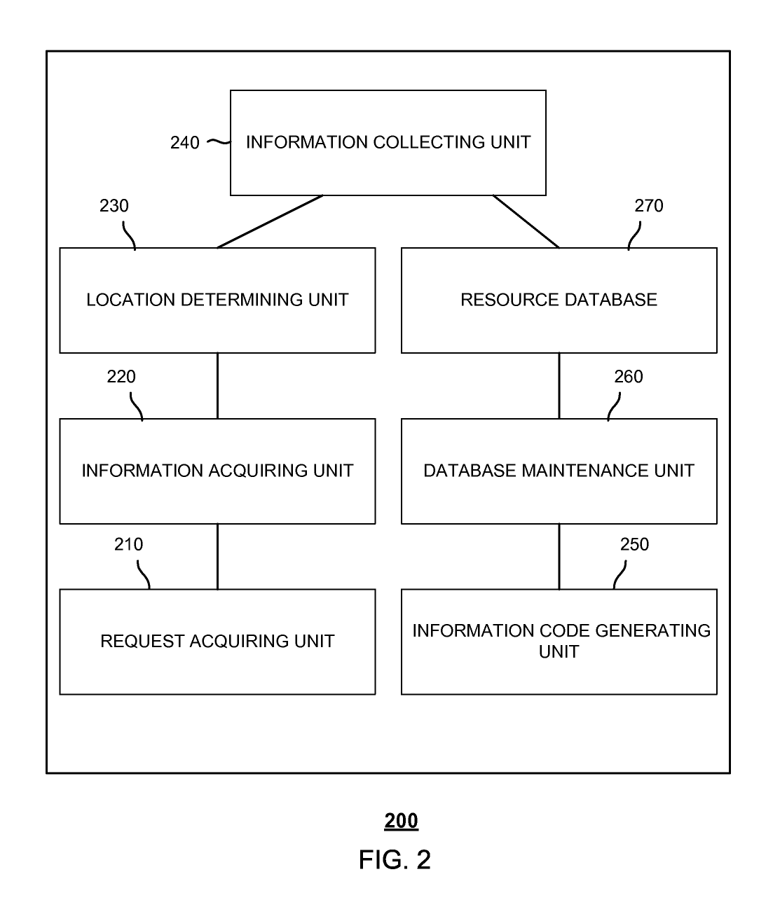

FIG. 2 is a structural diagram illustrating an embodiment of a device for collecting resource access information. In some embodiments, the device 200 implements the process 100 of FIG. 1A and comprises a request acquiring unit 210, an information acquiring unit 220, a location determining unit 230, and an information collecting unit 240. In some embodiments, the device 200 further includes an information code generating unit 250, a database maintenance unit 260, and a resource database 270.

In some embodiments, the information code generating unit 250 pre-generates the same information code or the same QR code for the same resource content and uses the pre-generated information codes for advertising at all advertisement delivering locations, without having to generate a different information code or a different QR code for each advertisement delivering location. The generation of the information code or the QR code is already understood by one of ordinary skill in the art and will not be further described for conciseness.

In some embodiments, the database maintenance unit 260 maintains the resource database 270.

In some embodiments, the resource database 270 stores an advertisement delivering location corresponding to each resource content, and geographic location information corresponding to the advertisement delivering locations. In some embodiments, the geographic location information corresponding to the advertisement delivering locations is represented by latitude and longitude information. The advertisement delivering locations can also be represented by specific names, identifiers, themes, etc. In addition, the resource database can also include advertising cooperation channel information.

After the user terminal scans the information code to acquire the resource content, the user terminal is to send an access request relating to the resource content. In some embodiments, the resource content is represented as a URL, and the access request is to also include geographic location information of the user terminal.

In some embodiments, the request acquiring unit 210 acquires the access request sent by the user terminal after the user terminal has scanned the information code.

In some embodiments, the information acquiring unit 220 acquires the resource content and the geographic location information of the user terminal from the access request. In some embodiments, the acquired geographic location information can be represented as latitude and longitude information.

In some embodiments, the request acquiring unit 210 receives in real time an access request sent by a user terminal. In some embodiments, the request acquiring unit 210 records the received access request in an access log. Subsequently, the request acquiring unit 210 acquires the recorded access request sent by the user terminal from the access log periodically or in real time when access occurs.

In some embodiments, the location determining unit 230 determines an advertisement delivering location in the resource database 270 corresponding to the resource content and that is closest to the geographic location information of the user terminal. As used above, “distance” can be the planar distance between two points, or “distance” can be the distance between two points on a spherical surface.

In some embodiments, the information collecting unit 240 collects session access information relating to the advertisement delivering location. All session access following the access request can be regarded as traffic caused by the advertisement delivering location. Therefore, the information collecting unit 240 records the session access information following the access request as resource access information corresponding to the advertisement delivering location. In some embodiments, the above-described session access information includes a user terminal IP address, access times, entry page URLs, entry page access origin page URLs, at least one browser feature, etc.

By using the device 200, the session access information can be collected to analyze the effectiveness of advertisement delivering based on the resource access information. For example, optimal advertisement delivering location analysis, optimal advertisement delivering time interval analysis, etc. can be performed. Various specific parameters, such as PV, UV, bounce rate, conversion rate, and new visitor percentage, can be calculated for advertisement delivering and can then be referred to for personalized, targeted advertisement delivering. For example, an effectiveness assessment report relating to the parameters can be generated based on a set template for each resource advertisement. In another example, an audience behavior model, a resource thermodynamic map model, or another model can be established. In yet another example, the advertisement delivering strategy can be adjusted based on an advertisement delivering model.

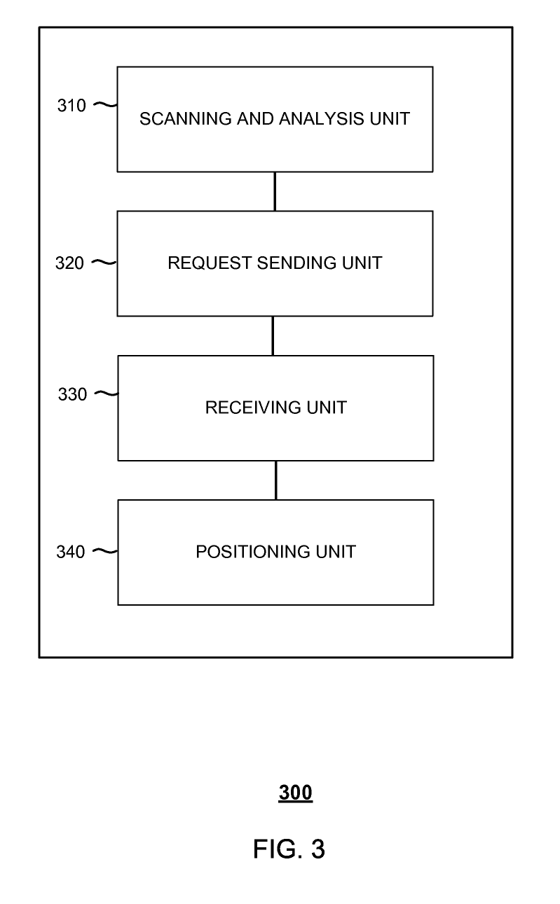

FIG. 3 is a structural diagram illustrating another embodiment of a device for collecting resource access information. In some embodiments, this device 300 implements the process 1000 of FIG. 1B, corresponds to a user terminal, and includes a scanning and analysis unit 310, a request sending unit 320, and a receiving unit 330. In some embodiments, the device 300 further includes a positioning unit 340.

In some embodiments, the scanning and analyzing unit 310 scans information codes or QR codes to acquire resource access content. For example, the scanning and analysis unit 310 includes a picture-taking function and code-analyzing function of the user terminal itself, and can be implemented as a built-in camera and a QR analyzer executing on a processor.

In some embodiments, the request sending unit 320 sends an access request including geographic location information of the device 300 (user terminal) to a server and corresponding to the resource access content.

In some embodiments, the receiving unit 330 receives a service response from a server.

In some embodiments, the positioning unit 340 acquires geographic location information of the device 300 (the user terminal). For example, by implementing a positioning technique, such as GPS positioning, Wi-Fi positioning, or base station positioning, the positioning unit 340 can obtain latitude and longitude information of the device 300 (user terminal), which can uniquely determine the geographic location information of the device 300 (user terminal).

Thus, the server can acquire resource content and user terminal geographic location information from the access request. The server determines an advertisement delivering location in the resource database corresponding to the resource content and that is closest to the geographic location information of the device 300 (user terminal), and collects access information relating to the advertisement delivering location.

Please note that information codes are used as the medium for resource content in all embodiments of the present application. However, the present application is not limited to the information codes and can also relate to other types of information codes, such as QR codes, bar codes, etc.

FIG. 4 is a diagram illustrating an embodiment of a system for collecting resource access information. In some embodiments, the system 400 includes a client 410 connected to a server 420 via a network 430.

In some embodiments, the client 410 scans an information code to acquire resource access content and sends an access request to the server 420.

Upon receiving the access request, the server determines a geographic location of the client 410, and collects session access information.

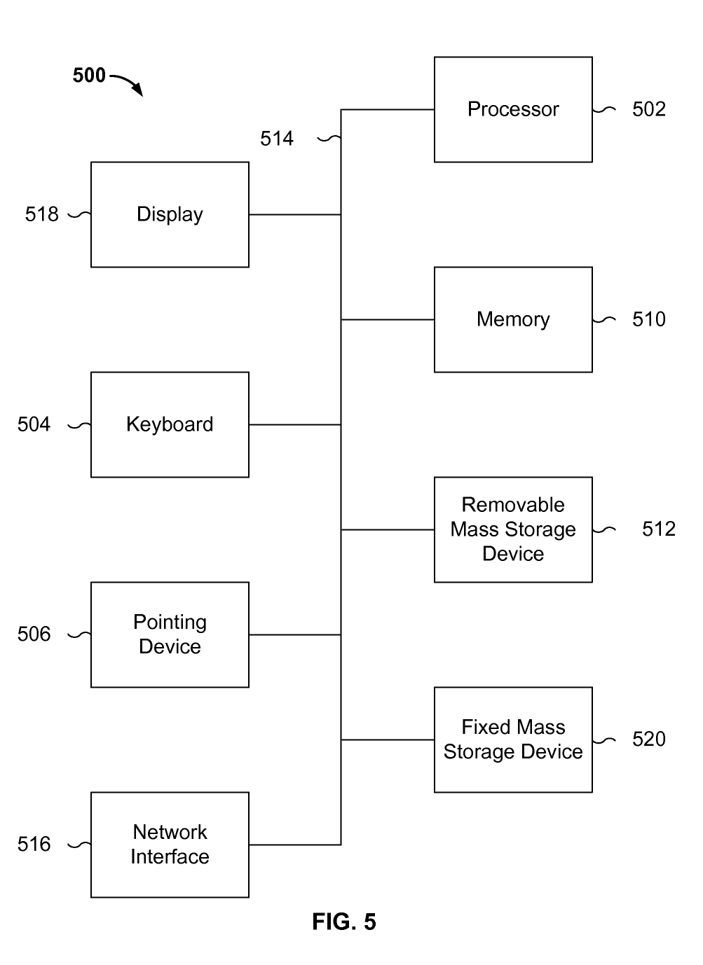

FIG. 5 is a diagram illustrating an embodiment of a computer system for collecting resource access information. As will be apparent, other computer system architectures and configurations can be used to collect resource access information. Computer system 500, which includes various subsystems as described below, includes at least one microprocessor subsystem (also referred to as a processor or a central processing unit (CPU)) 502. For example, processor 502 can be implemented by a single-chip processor or by multiple processors. In some embodiments, processor 502 is a general purpose digital processor that controls the operation of the computer system 500. Using instructions retrieved from memory 510, the processor 502 controls the reception and manipulation of input data, and the output and display of data on output devices (e.g., display 518).

Processor 502 is coupled bi-directionally with memory 510, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 502. Also as is well known in the art, primary storage typically includes basic operating instructions, program code, data, and objects used by the processor 502 to perform its functions (e.g., programmed instructions). For example, memory 510 can include any suitable computer-readable storage media, described below, depending on whether, for example, data access needs to be bi-directional or uni-directional. For example, processor 502 can also directly and very rapidly retrieve and store frequently needed data in a cache memory (not shown).

A removable mass storage device 512 provides additional data storage capacity for the computer system 500, and is coupled either bi-directionally (read/write) or uni-directionally (read only) to processor 502. For example, storage 512 can also include computer-readable media such as magnetic tape, flash memory, PC-CARDS, portable mass storage devices, holographic storage devices, and other storage devices. A fixed mass storage 520 can also, for example, provide additional data storage capacity. The most common example of mass storage 520 is a hard disk drive. Mass storage 512, 520 generally store additional programming instructions, data, and the like that typically are not in active use by the processor 502. It will be appreciated that the information retained within mass storage 512 and 520 can be incorporated, if needed, in standard fashion as part of memory 510 (e.g., RAM) as virtual memory.

In addition to providing processor 502 access to storage subsystems, bus 514 can also be used to provide access to other subsystems and devices. As shown, these can include a display monitor 518, a network interface 516, a keyboard 504, and a pointing device 506, as well as an auxiliary input/output device interface, a sound card, speakers, and other subsystems as needed. For example, the pointing device 506 can be a mouse, stylus, track ball, or tablet, and is useful for interacting with a graphical user interface.

The network interface 516 allows processor 502 to be coupled to another computer, computer network, or telecommunications network using a network connection as shown. For example, through the network interface 516, the processor 502 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 502 can be used to connect the computer system 500 to an external network and transfer data according to standard protocols. For example, various process embodiments disclosed herein can be executed on processor 502, or can be performed across a network such as the Internet, intranet networks, or local area networks, in conjunction with a remote processor that shares a portion of the processing. Additional mass storage devices (not shown) can also be connected to processor 502 through network interface 516.

An auxiliary I/O device interface (not shown) can be used in conjunction with computer system 500. The auxiliary I/O device interface can include general and customized interfaces that allow the processor 502 to send and, more typically, receive data from other devices such as microphones, touch-sensitive displays, transducer card readers, tape readers, voice or handwriting recognizers, biometrics readers, cameras, portable mass storage devices, and other computers.

The computer system shown in FIG. 5 is but an example of a computer system suitable for use with the various embodiments disclosed herein. Other computer systems suitable for such use can include additional or fewer subsystems. In addition, bus 514 is illustrative of any interconnection scheme serving to link the subsystems. Other computer architectures having different configurations of subsystems can also be utilized.

The units described above can be implemented as software components executing on one or more general purpose processors, as hardware such as programmable logic devices and/or Application Specific Integrated Circuits designed to perform certain functions or a combination thereof. In some embodiments, the units can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units may be implemented on a single device or distributed across multiple devices. The functions of the units may be merged into one another or further split into multiple sub-units.

The methods or algorithmic steps described in light of the embodiments disclosed herein can be implemented using hardware, processor-executed software modules, or combinations of both. Software modules can be installed in random-access memory (RAM), memory, read-only memory (ROM), electrically programmable ROM, electrically erasable programmable ROM, registers, hard drives, removable disks, CD-ROM, or any other forms of storage media known in the technical field.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a request acquiring unit configured to acquire an access request sent by a user terminal, the access request being generated by the user terminal based on a scanned information code;
an information acquiring unit configured to acquire resource content and geographic location information of the user terminal based on the access request;
a location determining unit configured to determine an advertisement delivering location from a resource database that corresponds to the resource content and that is closest to the geographic location information of the user terminal; and
an information collecting unit configured to collect session access information relating to the advertisement delivering location.

2. The system as described in claim 1, wherein the resource content corresponds to a uniform resource locator (URL).

3. The system as described in claim 1, wherein the request acquiring unit is further is configured to:
acquire in real time the access request sent by the user terminal; or
acquire the access request from an access log periodically or in real time when access Occurs.

4. The system as described in claim 1, wherein the information collecting unit is further configured to:
collect session access information subsequent to the access request; and
obtain resource access information corresponding to the advertisement delivering location based on the session access information obtained subsequent to the access request, the session access information comprising a user terminal IP address, an access time, an entry page URL, an entry page access origin page URL, at least one browser feature, or any combination thereof.

5. The system as described in claim 1, further comprising:
an information code generating unit configured to generate same information code for same resource content in advance and using the same information code for advertising at all advertisement delivering locations; and
a database maintenance unit configured to maintain the resource database including an advertisement delivering location corresponding to each resource content, and geographic location information corresponding to the advertisement delivering locations.

6. The system as described in claim 1, wherein the information collecting unit is further configured to determine whether to eliminate the advertisement delivering location based on the session access information.

7. A system for collecting resource access information, comprising:
a scanning and analyzing unit configured to scan an information code to acquire resource access content; and
a request sending unit configured to send an access request relating to the resource access content to a server, the access request including geographic location information of a user terminal, wherein:
the server determines an advertisement delivering location in a resource database that corresponds to the resource access content and that is closest to the geographic location information of the user terminal, and collects access information relating to the advertisement delivering location.

8. A method for collecting resource access information, comprising:
acquiring an access request sent by a user terminal, the access request being generated by the user terminal based on a scanned information code;
acquiring resource content and geographic location information of the user terminal based on the access request;
determining an advertisement delivering location from a resource database that corresponds to the resource content and that is closest to the geographic location information of the user terminal; and
collecting session access information relating to the advertisement delivering location.

9. The method as described in claim 8, wherein the resource content corresponds to a uniform resource locator (URL).

10. The method as described in claim 8, wherein the acquiring of the access request comprises:
acquiring in real time the access request sent by the user terminal; or
acquiring the access request from an access log periodically or in real time when access occurs.

11. The method as described in claim 8, wherein the collecting of the session access information relating to the advertisement delivering location comprises:
collecting session access information subsequent to the access request; and
obtaining resource access information corresponding to the advertisement delivering location based on the session access information obtained subsequent to the access request, the session access information comprising a user terminal IP address, an access time, an entry page URL, an entry page access origin page URL, at least one browser feature, or any combination thereof.

12. The method as described in claim 8, further comprising:
generating same information code for same resource content in advance and using the same information code for advertising at all advertisement delivering locations; and
maintaining the resource database including an advertisement delivering location corresponding to each resource content, and geographic location information corresponding to the advertisement delivering locations.

13. The method as described in claim 8, further comprising:
determining whether to eliminate the advertisement delivering location based on the session access information.

14. A method for collecting resource access information, comprising:
scanning an information code to acquire resource access content; and
sending an access request relating to the resource access content to a server, the access request including geographic location information of a user terminal, wherein:
the server determines an advertisement delivering location in a resource database that corresponds to the resource access content and that is closest to the geographic location information of the user terminal, and collects access information relating to the advertisement delivering location.

15. A computer program product for collecting resource access information, the computer program product being embodied in a tangible non-transitory computer readable storage medium and comprising computer instructions for:
acquiring an access request sent by a user terminal, the access request being generated by the user terminal based on a scanned information code;
acquiring resource content and geographic location information of the user terminal based on the access request;
determining an advertisement delivering location from a resource database that corresponds to the resource content and that is closest to the geographic location information of the user terminal; and
collecting session access information relating to the advertisement delivering location.

16. A computer program product for collecting resource access information, the computer program product being embodied in a tangible non-transitory computer readable storage medium and comprising computer instructions for:
scanning an information code to acquire resource access content; and
sending an access request relating to the resource access content to a server, the access request including geographic location information of a user terminal, wherein:
the server determines an advertisement delivering location in a resource database that corresponds to the resource access content and that is closest to the geographic location information of the user terminal, and collects access information relating to the advertisement delivering location.
